(19) United States
(12) Patent Application Publication
(10) Pub. No.: US 2016/0223324 A1
(43) Pub. Date: Aug. 4, 2016

(54) DEVICE FOR THE PNEUMATIC MEASUREMENT OF AN OBJECT

(71) Applicant: STOTZ FEINMESSTECHNIK GMBH, Gerlingen (DE)

(72) Inventor: Milan Stamenkovic, Stuttgart (DE)

(73) Assignee: STOTZ FEINMESSTECHNIK GMBH, Gerlingen (DE)

(21) Appl. No.: 15/021,370

(22) PCT Filed: Sep. 8, 2014
(86) PCT No.: PCT/EP2014/069112

§ 371 Date: Mar. 11, 2016

(30) Foreign Application Priority Data
Sep. 18, 2013 (DE) 102013218731.9

(51) Int. Cl. G01B 13/10

(52) U.S. Cl. CPC G01B 13/10

(57) ABSTRACT

The invention relates to a device for the pneumatic measurement of an object, comprising a measuring nozzle that is fed by a compressed air source via a measuring line, a pneumatic converter integrated in the measuring line, and a switching element arranged upstream of the pneumatic converter in the measuring line, which switching element can be switched to a releasing state releasing a fluid connection between the compressed air source and the measuring nozzle, and to blocking state blocking the fluid connection between the compressed air source and the measuring nozzle. Furthermore, a low-pressure line branching off the measuring line upstream of the switching element and having at least one throttle element is provided in order to detect the presence of an object to be measured in the area of the measuring nozzle by means of a pneumatic measurement under reduced pressure with respect to a measurement of an object. The low-pressure line terminates between the switching element and the pneumatic converter in the measuring line. An electronic control device is configured to switch the electrically controllable switching element to and fro between the releasing state and the blocking state subject to an output signal of the pneumatic converter.

The present invention relates to an apparatus for the pneumatic measurement of an object having at least one measurement nozzle which is fed from a compressed air source via a measurement line, having a pneumatic converter which is integrated into the measurement line and which is configured to generate an electrical output signal based on a pressure in the measurement line, said electrical output signal indicating a spacing of the measurement nozzle from a wall section of an object to be measured, and having a switching element which is arranged upstream of the pneumatic converter in the measurement line and which can be switched into a release state releasing a fluid connection between the compressed air source and the measurement nozzle and into a blocking state blocking the fluid connection between the compressed air source and the measurement nozzle, wherein a low-pressure line which branches off from the measurement line upstream of the switching element and which has at least one restrictor element is provided to detect the presence of an object to be measured in the region of the measurement nozzle by means of a pneumatic measurement at a pressure reduced with respect to an object measurement.

Pneumatic object measurement devices are used in many areas of the art, for example in the quality inspection of inner diameters or outer diameters and in measurements of 2D and 3D shapes and positions. The switching element serves to interrupt the air supply of the measurement nozzle in the measurement breaks to limit the expensive loss of air. Since experience has shown that a manually actuated switching element is frequently not used by the operators for reasons of laziness, the actuation of the switching element is preferably based on an automatic workpiece recognition. It can take place pneumatically, like the actual measurement, namely via the low-pressure line which forms a bypass line to the measurement line with a closed switching element and which can detect a presence of a workpiece at the measurement position at reduced pressure and thus at reduced air loss. Such an apparatus is described in DE 2 216 679, wherein the low-pressure line leads to a separate signal nozzle which has a cross-section reduced with respect to the measurement nozzle. The switching element is pneumatically connected to the low-pressure line and is controlled by it.

The provision of two parallel lines, which are typically to be led from corresponding base sections of the device up to a measurement head arranged remotely, is associated with additional manufacturing effort. In addition, the components of the low-pressure system take up a relatively large amount of construction space, above all also due to the additional signal nozzle in the measurement means so that further measurement nozzles may possibly not be able to be accommodated there.

There is therefore a desire to make possible a simpler and less expensive design in pneumatic object measurement devices having automatic workpiece recognition.

This object is satisfied by an apparatus having the features of claim 1.

Provision is made in accordance with the invention that the low-pressure line between the switching element and the pneumatic converter opens into the measurement line, wherein the switching element is electrically controllable and an electronic control device is provided which is configured to switch the switching element to and fro between the release state and the blocking state in dependence on an output signal.

The possibility is opened up by combining the low-pressure line with the measurement line at a point disposed upstream of the pneumatic converter of utilizing the measurement line itself for a workpiece recognition at a reduced pressure. Only one line, namely the measurement line, then has to be conducted from the converter to the measurement head so that the design of the device is considerably simplified. The provision of an independent signal nozzle for the workpiece recognition is also dispensed with. A special advantage can be seen in that measurement means which are present in an apparatus in accordance with the invention and which are not equipped with signal nozzles can be used without problem.

Further developments of the invention are set forth in the dependent claims, in the description and in the enclosed drawings.

In accordance with an embodiment of the invention, the apparatus is configured for an object measurement in individual consecutive measurement procedures, wherein the control device is configured to switch the switching element into the blocking state after each completed measurement procedure. No wait is therefore made, for instance, until the workpiece and the measurement nozzle have moved away from one another. The air loss is minimized in this manner.

The control device can also be configured to switch back into the release state, starting from the blocking state, when the output signal of the pneumatic converter falls below a threshold value. The falling below of the threshold value signals that a measurement object is close to the measurement nozzle. As soon as a new workpiece to be measured is positioned at the measurement nozzle, the pneumatic converter is set below the regular measurement pressure so that a correspondingly exact measurement can take place. It is preferably waited until a predefined time has elapsed after the switching of the switching element into the release state before a measured value output by the pneumatic converter is taken over and is stored in a memory. The control device could alternatively also be configured such that a takeover of a measured value only takes place, independently of an elapsed time, when a time change rate of the output signal falls below a threshold value. It is ensured by both aforesaid measures that a measurement only takes place when the measurement circumstances have stabilized or “calmed down”.

It is preferred for the switching element, the pneumatic converter and the electronic control device to be accommodated in a common housing. This allows a particularly compact manner of construction.

The low-pressure line can likewise be completely accommodated in the housing so that its presence cannot be recognized at all from the outside. Such a housing is compatible with all commercial measurement heads.

A further embodiment of the invention provides that the measurement nozzle is arranged in a measurement head separate from the housing, in particular in a test mandrel or in a measurement ring. The measurement head can be connectable to a base housing of the device via a flexible hose including the measurement line. A separate signal line is not necessary.

Two oppositely disposed measurement nozzles can also be arranged in such a measurement head in order e.g. to facilitate the measurement of boreholes.

The switching element is configured as a solenoid valve in accordance with a special embodiment. Such a solenoid valve is simple to control and simple to switch.

A signal amplifier is preferably associated with the pneumatic converter for the electronic amplification of the output signal. It thereby becomes possible to work at a particularly low pressure in the low-pressure system and nevertheless reliably to recognize the presence of a workpiece at the measurement nozzle.

The restrictor element of the low-pressure line can be adjustable to allow an adaptation of the workpiece recognition to different application situations.

The invention will be described in the following by way of example with reference to the drawings.

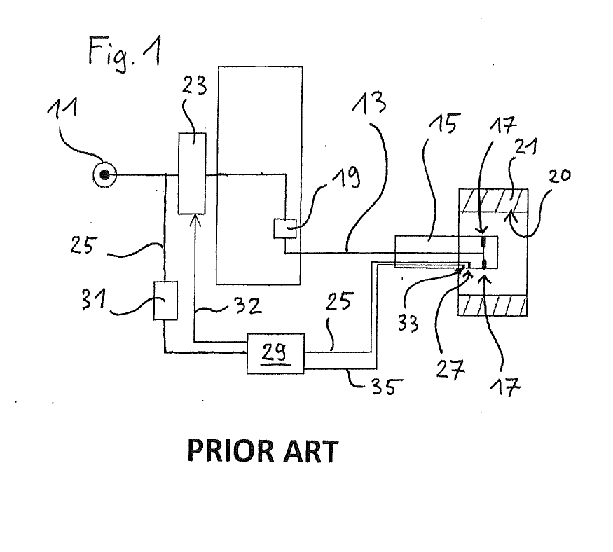

FIG. 1 shows an apparatus for a pneumatic measurement of an object in accordance with the prior art;

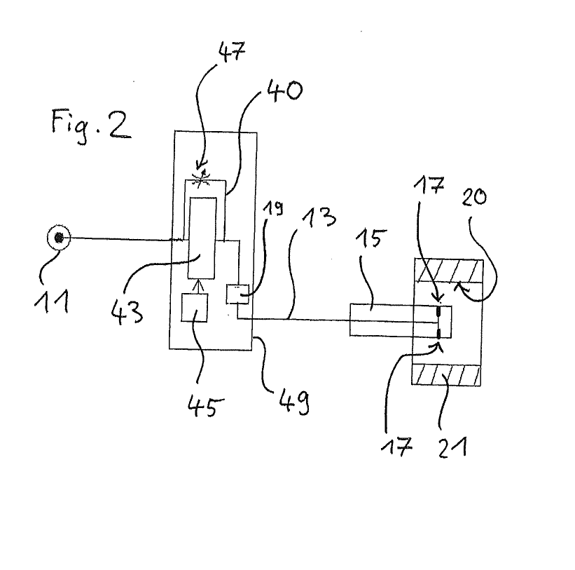

FIG. 2 shows an apparatus in accordance with the invention for the pneumatic measurement of an object; and

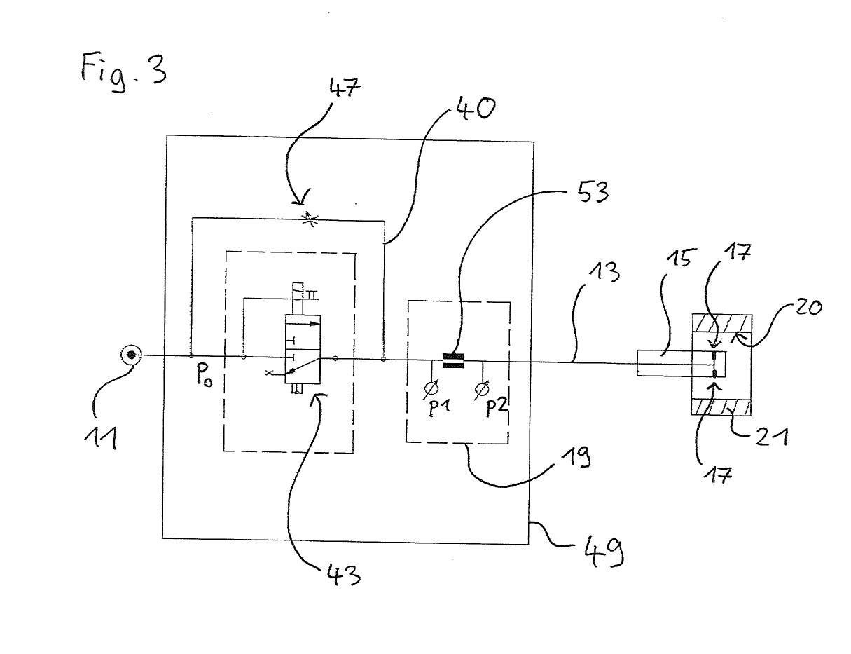

FIG. 3 is a different representation of the apparatus shown in FIG. 2.

The apparatus designed in accordance with the prior art and shown in FIG. 1 for the pneumatic measurement of an object comprises a compressed air source 11 and a measurement line 13 which is connected thereto and which leads to a measurement head 15. The measurement head 15 is here designed as a test mandrel for measuring inner diameters and has a pair of measurement nozzles 17 which are directed away from one another. A pneumatic converter 19 integrated into the measurement line 19 serves to generate an electrical output signal in a generally known manner on the basis of a pressure in the measurement line 13, said electrical output signal indicating a spacing of the measurement nozzles 17 from an adjacent wall. The measurement head 15 is shown introduced into a borehole 20 of a workpiece 21 in FIG. 1. The diameter of the borehole 20 can be checked by evaluating the electrical output signal.

To be able to interrupt the compressed air feed to the measurement nozzles 17 in the measurement breaks between consecutive measurement procedures, a switching element 23 in the form of a valve is integrated into the measurement line 13 at a point disposed upstream of the pneumatic converter 19. The switching element 23 is in communication with the evaluation unit 29 of a system for the automatic workpiece recognition. A low-pressure line 25 which is connected to the compressed air source 11 via a pressure reducer 31 is associated with the evaluation unit 29. The low-pressure line 25 leads to a measurement head 15 and opens there into a signal nozzle 27 which has a diameter reduced with respect to the measurement nozzles 17. The switching element 23 can be controlled by means of a pneumatic control line 32 in a manner such that the measurement nozzles 17 are only supplied with compressed air via the measurement line 13 when the measurement head 15 is introduced into a borehole 20 to be measured. In addition, a proximity sensor 33 is integrated into the measurement head 15 for the workpiece recognition and is connected to the evaluation unit 29 via an electrical signal line 35.

The workpiece recognition by means of the signal nozzle 27 takes place at a reduced pressure due to the pressure reducer 31 and thus with reduced air loss. Apparatus such as that shown in FIG. 1, for example, have a measurement pressure of approximately 3 bar and a signal pressure for the workpiece recognition of approximately 0.1 bar.

FIG. 2 shows an apparatus in accordance with the invention for the pneumatic measurement of an object which in principle has a similar design to the measurement apparatus shown in FIG. 1. Components having the same effect are accordingly provided with the same reference numerals. In the apparatus in accordance with the invention, however, the low-pressure line 40 is not led up to the measurement head 15. It rather opens into the measurement line 13 upstream of the pneumatic converter 19, that is it only bridges the switching element 43. The switching element 43 is furthermore configured as an electrically controllable solenoid valve which is electrically connected to an electronic control device 45. The electronic control device 45 is electrically connected to the pneumatic converter 19 and is configured selectively to switch the switching element 43 to passage or to block in dependence on an output signal of the pneumatic converter 19. In order in this respect also to be able to work with weak output signals, a signal amplifier, not shown in FIG. 2, is associated with the pneumatic converter 19 for the electronic amplification of the output signal.

As shown, the switching element 43, the pneumatic converter 19 and the electronic control device 45 are accommodated in a common housing 49. The low-pressure line 40 is also arranged completely within the housing 49.

It can be seen from the detailed representation in accordance with FIG. 3 that the pneumatic converter 19 includes a measurement restrictor 53 as well as two pressure sensors p1 and p2. The pneumatic measurement is ultimately based on a determination of a pressure drop over the measurement restrictor 53, wherein the pneumatic converter 19 generates an electrical output signal which, proportional to this pressure drop, is in relation to the input pressure p1 of the pneumatic converter 19.

In the following, an exemplary operating routine of the apparatus shown in FIGS. 2 and 3 will be described starting from a state of rest with disconnected measurement air. In this state of rest, the switching element 43 is switched to blocking, as shown in FIG. 3, and the input pressure p1 applied at the measurement restrictor 53 amounts to only a fraction of the supply pressure p0, in particular to less than 10% of the supply pressure p0, for example to approximately 0.1 bar. The amount of the low pressure used for the workpiece recognition can be regulated by means of an adjustable restrictor element 47.

If the measurement head 15 is not introduced into a bore 20, the output pressure p2 present downstream of the measurement restrictor 53 is considerably lower than the input pressure p1 and the pressure difference p1−p2 has a comparatively high value. In this state, which so-to-say corresponds to a “waiting for the workpiece 21”, the output signal of the pneumatic converter 19 is continuously monitored by the electronic control device 45.

When the measurement head 15 is introduced into a borehole 20, the output pressure p2 increases and the pressure difference p1−p2 falls accordingly. As soon as the pressure difference p1−p2 falls below a threshold value, the electronic control device 45 controls the switching element 43 and provides for its opening. The input pressure p1 increases accordingly until the pressure p0 provided by the compressed air source 11 is almost reached. The electronic control device 45 now waits until a predetermined calming time has elapsed since the opening of the switching element 43. The actual measurement is only carried out after the end of the calming time and the respective measured value is stored in a memory device. The switching element 43 is closed again directly subsequently, which corresponds to a switching off of the measurement air. The input pressure p1 drops to approximately 0.1 bar again. The measurement head 15 can now—preferably after the end of a further predefined time period—be led out of the borehole 20 of the workpiece 21. The workpiece 21 is then removed and a new workpiece 21 is provided. As soon as the measurement head 15 is introduced into the borehole 20 of the new workpiece 21, the above-described routine can start again.

The operating routine was described for the example of consecutive individual measurements. The apparatus shown in FIGS. 2 and 3 is in principle also suitable for dynamic measurements, wherein a switching off of the measurement air after each takeover of a measured value can optionally be dispensed with.

The invention allows the provision of a particularly compact pneumatic object measurement device which is simple to handle, which has an automatic measurement air shut off and with which both inner diameter measurements and outer diameter measurements and also shape and position measurements can be carried out.

### REFERENCE NUMERAL LIST

11 compressed air source
13 measurement line
15 measurement head
17 measurement nozzle
19 pneumatic converter
20 borehole
21 workpiece
23 switching element
25 low-pressure line
27 signal nozzle
29 evaluation unit
31 pressure reducer
32 pneumatic control line
33 proximity sensor
35 electrical signal line
40 low-pressure line
43 switching element
45 electronic control device
47 adjustable restrictor element
49 housing
53 measurement restrictor
p0 pressure provided by the compressed air source
p1 input pressure
p2 output pressure

1-10. (canceled)

11. An apparatus for the pneumatic measurement of an object, comprising at least one measurement nozzle which is fed from a compressed air source via a measurement line; a pneumatic converter which is integrated into the measurement line and which is configured to generate an electrical output signal based on a pressure in the measurement line, said electrical output signal indicating a spacing of the measurement nozzle from a wall section of an object to be measured; and a switching element which is arranged upstream of the pneumatic converter in the measurement line and which can be switched into a release state releasing a fluid connection between the compressed air source and the measurement nozzle and into a blocking state blocking the fluid connection between the compressed air source and the measurement nozzle, wherein a low-pressure line which branches off from the measurement line upstream of the switching element and which has at least one restrictor element is provided to detect the presence of an object to be measured in the region of the measurement nozzle by means of a pneumatic measurement at a pressure reduced with respect to an object measurement, wherein the low-pressure line between the switching element and the pneumatic converter opens into the measurement line, wherein the switching element is electrically controllable and an electronic control device is provided which is configured to switch the switching element to and fro between the release state and the blocking state in dependence on an output signal of the pneumatic converter.

12. The apparatus in accordance with claim 11, wherein the apparatus is configured for an object measurement in individual consecutive measurement procedures, wherein the control device is configured to switch the switching element into the blocking state after every completed measurement procedure.

13. The apparatus in accordance with claim 12, wherein the control device is also configured to switch the switching device back into the release state, starting from the blocking state, when the output signal of the pneumatic converter falls below a threshold value.

14. The apparatus in accordance with claim 11, wherein the switching element, the pneumatic converter and the electronic control device are accommodated in a common housing.

15. The apparatus in accordance with claim 14, wherein the low-pressure line is likewise completely accommodated in the housing.

16. The apparatus in accordance with claim 14, wherein the measurement nozzle is arranged in a measurement head separate from the housing.

17. The apparatus in accordance with claim 16, wherein the measurement nozzle is arranged in a test mandrel or a measurement ring.

18. The apparatus in accordance with claim 16, wherein two oppositely disposed measurement nozzles are arranged in the measurement head.

19. The apparatus in accordance with claim 11, wherein the switching element is configured as a solenoid valve.

20. The apparatus in accordance with claim 11, wherein a signal amplifier is associated with the pneumatic converter for the electronic amplification of the output signal.

21. The apparatus in accordance with claim 11, characterized in that the restrictor element of the low-pressure line is adjustable.
